(19) United States
(12) Patent Application Publication
(10) Pub. No.: US 2024/0071046 A1
(43) Pub. Date: Feb. 29, 2024

(54) System and Method for Load Bay State Detection

(71) Applicant: ZEBRA TECHNOLOGIES CORPORATION, Lincolnshire, IL (US)

(72) Inventors: Santiago Romero, Mount Airy, MD (US); Aditya Mogha, Bengaluru (IN)

(21) Appl. No.: 17/899,281

(22) Filed: Aug. 30, 2022

(51) Int. Cl. G06V 10/764; G06V 20/50

(52) U.S. Cl. CPC G06V 10/764; G06V 20/50

(57) ABSTRACT

An example method includes: at a load bay, controlling an imaging device disposed at the load bay to capture a plurality of images of the load bay; at a computing device communicatively coupled to the imaging device: obtaining a subset of the plurality of images; obtaining an image classification for each image in the subset; and determining a load bay state based on the image classifications of the images in the subset.

### BACKGROUND

Transport and logistics and other facilities may have load bays where storage containers are loaded with items. Storage containers used for transporting items, such as trailers, shipping containers, and the like, can hold items with widely varying attributes (e.g., weight, dimensions, and the like). During transportation and handling operations, a container may be positioned at a load bay and the items may be loaded into the container, unloaded from the container, for processing at a facility, loaded onto other containers, and the like. The state of the load bay during a load process or when the load bay is empty may be used to facilitate management of resources. Detecting a load bay state based on a variety of attributes of the load bay (e.g., empty or occupied) and/or a container (e.g., a container door state), a variety of attributes of items in the container, and the varying physical arrangement of the items within the container, can render detection of the load bay state a complex operation that is difficult to monitor and execute. Such complex operations may often use expensive and computationally complex machine and computer vision systems.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for load bay state detection.

FIG. 2 is flowchart of a method of detecting a load bay state.

FIG. 3 is a flowchart of an example method of obtaining a subset at block 210 of the method of FIG. 2.

FIG. 4 is a flowchart of an example method of updating a stored load bay state at block 225 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: at a load bay, controlling an imaging device disposed at the load bay to capture a plurality of images of the load bay; at a computing device communicatively coupled to the imaging device: obtaining a subset of the plurality of images; obtaining an image classification for each image in the subset; and determining a load bay state based on the image classifications of the images in the subset.

Additional examples disclosed herein are directed to a system comprising: an imaging device having a field of view encompassing at least a portion of a load bay; a computing device configured to: control the imaging device to capture a plurality of images of the load bay; obtain a subset of the plurality of images; obtain an image classification for each image in the subset; and determine a load bay state based on the image classifications of the images in the subset.

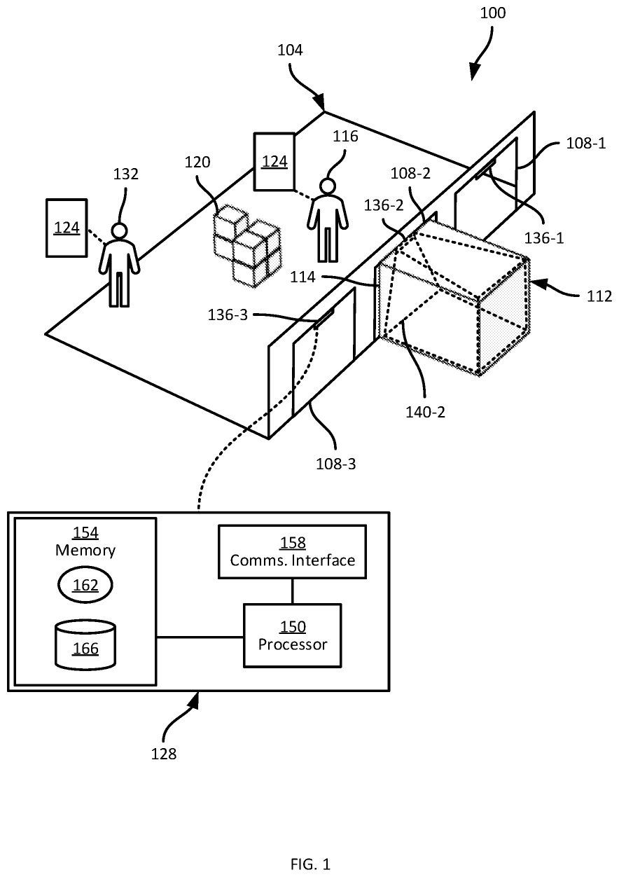

FIG. 1 depicts a system 100 for load bay state detection in accordance with the teachings of this disclosure. The system 100 includes a facility 104 (e.g., a warehouse, manufacturing facility, retail facility, transit facility such as an airport, or the like, a portion of which is illustrated in FIG. 1) with at least one load bay 108. As illustrated, the facility 104 includes a portion of a building, such as a cross dock or portion thereof, including load bays 108. In the illustrated example, three load bays 108-1, 108-2, and 108-3 are shown (collectively referred to as load bays 108, and generically referred to as a load bay 108; similar nomenclature may also be used for other components herein). The load bays 108 may, for example, be arranged along an outer wall of the facility 104, such that containers can approach the load bays 108 from the exterior of the facility 104. In other examples, smaller or greater numbers of load bays 108 may be included. Further, although a single facility 104 is illustrated in FIG. 1, in some examples, the load bays 108 may be distributed across multiple physically distinct facilities. The load bays 108 are illustrated as being dock structures enabling access from within the facility 104 to an exterior of the facility 104 where a container 112 is positioned. In other examples, one or more of the load bays 108 may be implemented as a load station within the facility 104, to load or unload containers that are processed inside the facility 104.

Each load bay 108 is configured to accommodate a container, such as the example container 112 shown in FIG. 1. In particular, the container 112 is shown at the load bay 108-2. The container 112 can be any container transportable by at least one of a vehicle, a train, a marine vessel, an airplane or the like, and configured to store transportable goods such as boxed and/or unboxed items and/or other types of freight. The container 112 may therefore be, for example, a semi-trailer including an enclosed box affixed to a platform including one or more sets of wheels and a hitch assembly for towing by a powered vehicle. In further examples, the container 112 may be the box portion of a box truck in which the container 112 is affixed to the body of the vehicle which also supports a cab, powertrain, and the like. In other examples, the container 112 can be a unit loading device (ULD) of the type employed to load luggage, freight and the like into aircraft. In such examples, the container 112 may be transported to and from load bays 108 by a vehicle such as a pallet truck or the like. In still further examples, a ULD is processed at a load bay 108 located within the facility 104 as noted above, rather than at a load bay 108 allowing access to the facility exterior.

Each load bay 108 includes an opening, e.g., in a wall of the facility 104, that enables staff and/or equipment within the facility 104 to access an interior of the container 112. For example, once the container 112 is positioned at the load bay 108-2 as shown in FIG. 1, e.g., with an open end 114 of the container (e.g., a wall with a door or other opening allowing access to an interior of the container 112) substantially flush with the opening of the load bay 108-2, a worker 116 within the facility 104 can begin moving items 120 from the facility 104 into the container 112. For a loading process, when the container 112 has been filled to a target level, a door of the container 112 can be closed, and the container 112 can be withdrawn from the load bay 108-2 to make way for another container. As will now be apparent, a similar process may be implemented to unload the container 112, e.g., by the worker 116, to take delivery of items at the facility 104 for further processing. Loading and unloading processes are referred to collectively herein as “load” processes.

The facility 104 may include a significant number of load bays 108 (e.g., some facilities may include hundreds of load bays 108), as well as a significant number of workers such as the worker 116. The size, weight, and/or handling requirements of the items 120 may vary from container to container. Further, performance targets may be applied to each load process, including the time available to fill a given container 112, the degree to which each container 112 is expected to be filled, and the like. Such constraints may also vary between load processes.

The worker 116 may carry or otherwise operate a client computing device 124, such as a wearable computer, a tablet computer, a smartphone, or the like. The device 124 may receive messages, e.g., from a server 128, containing instructions for the worker 116. The instructions may identify which items 120 are to be loaded into the current container 112, as well as the time available to load the container 112, the degree to which the container 112 is expected to be filled, and the like. The computing device 124 may also be mounted to a wall, suspended from the ceiling by a retention system, or other fixed portion of the facility 104 at or near the load bay 108-2. Each load bay 108 may include a device 124. One or more supervisors 132 may also be deployed throughout the facility 104, e.g., equipped with corresponding client devices 124. The supervisor 132 may be responsible for allocating resources, such as workers 116, to the load bays 108 shown in FIG. 1.

To assist in the allocation of resources to load bays 108, the system 100 can include respective sensor assemblies 136-1, 136-2, and 136-3 disposed at the load bays 108-1, 108-2, and 108-3. Each sensor assembly 136 includes at least one image sensor, such as an RGB camera. In other examples, the sensor assembly can include depth sensors, lidar sensors ultrasound sensors, trip detectors, sonar devices, or the like, in addition to the RGB camera or image sensor. For example, the system 100 may use image data to determine the state of the load bay 108 for use in resource and facility management, as described herein. Such a system may reduce material costs of the system 100 and simplify computational complexity of incorporating data from other sensors for applications in which load bay state detection is sufficient for resource and facility management. In other examples, the load bay state detection based on image data as described herein may supplement and provide additional information to load process metrics determined using additional sensor data.

Accordingly, each sensor assembly 136 is positioned at the corresponding load bay 108 such that a field of view (FOV) is aimed outwards from the load bay 108, into the interior of the container 112 docked at that load bay 108. An FOV 140-2 of the sensor assembly 136-2 is shown in FIG. 1. When the load bay 108 is empty, as load bay 108-1 is, the FOV of the corresponding sensor assembly 136-1 may still be aimed outwards from the load bay 108-1 to capture the region where a container 112 would be docked.

The sensor assemblies 136 are controllable, e.g., by the server 128, to capture sensor data, and in particular images corresponding to the load bay 108. For example, the images may depict the interior of docked containers 112, or an empty load bay 108. The server 128 may identify a load bay state, including a dock state (e.g., the dock is empty or occupied) and a trailer door state (e.g., NULL when the dock is empty, or either open, closed or ajar when the dock is occupied). When the dock state is occupied and the trailer door state is open, the load bay state may additionally include various trailer load properties (e.g., specifying the type of cargo, a lights out state, or the like). The load bay state, including the trailer door state and trailer load properties, may be updated periodically during a load process (e.g., by capturing and processing additional images). In some examples, the sensor assemblies 136 may include processing hardware and software to determine the load bay state for subsequent use by the server 128.

The load bay state may additionally be used to determine idle/active time as described below. The server 128 can be configured to determine when a container 112 or a load bay 108 is in an idle state, in which no items 120 are being placed in the container 112 (or removed from the container 112, in the case of an unloading process). The server 128 can further be configured to track accumulated periods of idleness.

The above-mentioned load bay state and metrics can be employed to assess and manage load processes at a facility.

Certain components of the server 128 are also shown in FIG. 1. The server 128 includes a central processing unit (CPU), also referred to as a processor 150, interconnected with a non-transitory computer readable storage medium, such as a memory 154. The memory 154 includes any suitable combination of volatile memory (e.g., Random Access Memory (RAM)) and non-volatile memory (e.g., read only memory (ROM), Electrically Erasable Programmable Read Only Memory (EEPROM), or flash). The processor 150 and the memory 154 each comprise one or more integrated circuits (ICs).

The server 128 also includes a communications interface 158, enabling the server 128 to exchange data with other computing devices, such as the client devices 124 and/or the sensor assemblies 136. The communications interface 158 therefore includes any suitable hardware (e.g., transmitters, receivers, network interface controllers and the like) allowing the server 128 to communicate, e.g., over local and/or wide area networks.

The memory 154 stores a plurality of computer-readable instructions, e.g., in the form of a load bay state detection application 162. The application 162 is executable by the processor 150 to implement various functionality performed by the server 128. In some examples, the functionality performed by the server 128 may be implemented by a suite of distinct applications. As will be discussed below, the application 162 implements a load bay state detection function, and may additionally implement an image classification function. The memory 154 can also store configuration parameters, such as various thresholds as discussed below, e.g., in a repository 166.

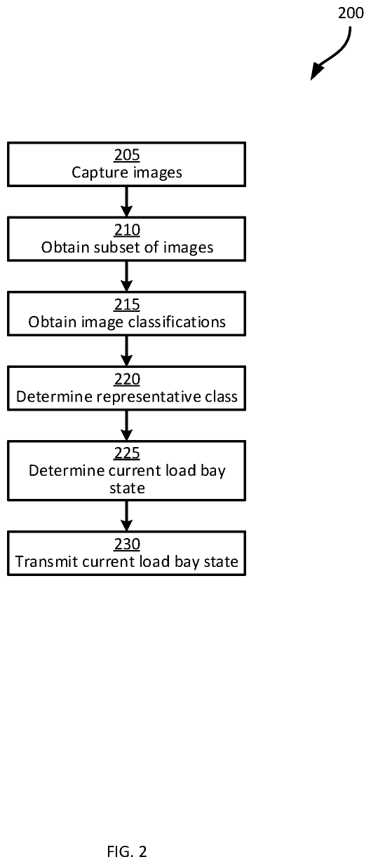

Turning to FIG. 2, a method 200 of load bay state detection is shown. The method 200 will be described in conjunction with an example performance of the method 200 within the system 100. In particular, the blocks of the method 200 are performed by the server 128 in this example, as configured via execution of the application 162 to determine the load bay state of one of the load bays 108. In other examples, the method 200 may be performed by other suitable devices and/or systems.

At block 205, the server 128 may control the sensor assemblies 136 to capture images of the respective load bays 108. The images may include images of the interior of a container, such as the container 112 docked at the load bay 108-2, as well as images of an empty load bay, such as the load bays 108-1 and 108-3.

At block 210, the server 128 may obtain a subset of the images captured by the sensor assemblies 136. The subset may represent a set of images captured within a threshold time of one another, so that the subset is likely to represent a single state of the load bay 108.

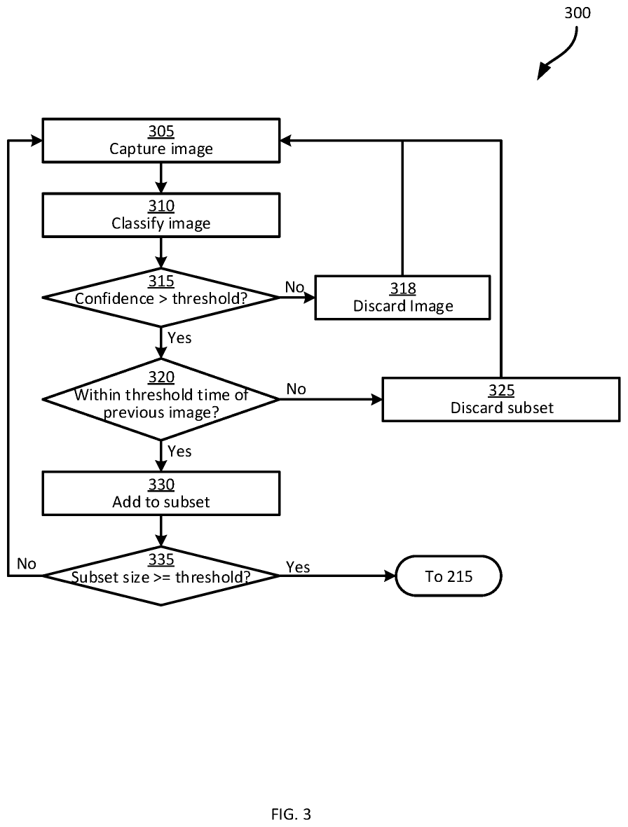

For example, referring to FIG. 3, an example method 300 of obtaining a subset of images is depicted. The method 300 may be performed, in some examples, by the sensor assembly 136 itself, during capture of the plurality of images. In other examples, the method 300 may be performed by the server 128 upon receipt of each image captured by the sensor assembly 136.

Preferably, the subset may be generated in real-time as the images are captured at block 205 of the method 200. Accordingly, at block 305, the server 128 controls the sensor assembly 136 to capture a single image of the respective load bay 108.

At block 310, the server 128 classifies the image captured at block 305 to obtain an image classification for the image. For example, the server 128 may employ one or more machine learning or artificial intelligence engines, such as an RGB (red-green-blue) image classifier based on a convolutional network, or the like. The classifier can include a multi-layer convolutional network, including but not limited to, a re-scaling layer, multiple convolutional layers, a flattening layer, multiple dense layers, and the like with specific parameters. The classifier may be trained based on images of multiple facilities and load bays under various environmental conditions (e.g., lighting conditions, etc.). Further, the classifier may be trained based on “early-stopping” with dropout and regularization to reduce the likelihood of overfitting.

The classifier may output an image classification for a given input image from a predefined set of image classifications. For example, a set of image classifications may include, but is not limited to, the following predefined classes: parking lot, trailer door closed, trailer empty, end workflow, lights out, mixed cargo, parcel cargo, and trailer door ajar. In other examples, other predefined image classes and/or combinations of image classes forming the set are also contemplated.

Accordingly, at block 310, the server 128 may determine an image classification for the image captured at block 305.

In addition to the image classification, the server 128 may also determine a confidence level in the accuracy of the determined image classification. Preferably, the server 128 may determine the load bay state based on images for which the image classification is accurately determined, and hence, at block 315, the server 128 may compare the confidence level for the image classification obtained at block 310 to a predetermined threshold confidence level. The threshold confidence level may be predetermined based on the expected accuracy of the image classifier as well as an error tolerance for the subsequently determined load bay state. For example, the threshold confidence level may vary based on customer and facility requirements.

If, at block 315, the confidence level for the image classification of the image captured at block 305 is below the threshold confidence level, then the server 128 proceeds to block 318. At block 318, the server 128 discards the image and returns to block 305 to capture another image.

If, at block 315, the confidence level for the image classification of the image captured at block 305 is above the threshold confidence level, then the server 128 proceeds to block 320.

At block 320, the server 128 determines whether the image captured at block 305 was captured within a threshold time of a preceding image (i.e., a most recently captured image) of the subset. In particular, images which are captured more than the threshold time apart from one another may be captured far enough apart that the state of the load bay may differ. That is, the image classifications and therefore the subsequently determined load bay states may be different between the two images and result in inaccurately determining the load bay state based on a subset which includes both images. The threshold time may therefore be selected to ensure that sequential images are likely to represent the same or similar load bay states and image classes.

Accordingly, if, at block 320, the server 128 determines that the image captured at block 305 was not captured within the predetermined threshold time of the preceding image of the subset, then the server 128 proceeds to block 325. At block 325, the server 128 discards the subset and returns to block 305 to capture a subsequent image and generate anew subset.

If, at block 320, the server 128 determines that the image captured at block 305 was captured within the predetermined threshold time of the preceding image of the subset, then the server 128 proceeds to block 330. Further, as will be appreciated, in some examples, the subset may be empty, and hence may not have a preceding image with which to compare the image captured at block 305. In such examples, the server 128 may proceed directly from block 315 to block 330.

At block 330, the server 128 adds the image captured at block 305 to the subset. In some examples, the subset may be a rolling subset to facilitate the capture of incremental changes in the load bay state. Accordingly, in some examples, prior to adding the image to the subset, the server 128 may check if the subset is at a threshold size. If the subset is at the threshold size, then the server 128 may remove the oldest image in the subset prior to adding the newest image captured at block 305. That is, the server 128 may remove the image from the beginning of the subset and add the image captured at block 305 to the end of the subset. If the subset is not yet at the threshold size, then the server 128 may add the image to the end of the subset.

At block 335, the server 128 determines if the subset is at the threshold size. The threshold size may be selected to further improve the accuracy of the load bay state, such that if a significant portion of the subset is classified under a certain image class, then that image class is likely to be representative of the load bay state at that point in time. The threshold size may further be selected at least partially in conjunction with the threshold time between sequential images, such that at least most of the images in the subset of the threshold size are likely to represent the same state of the load bay. The threshold size may be represented, for example, by a threshold number of images in the subset.

If, at block 335, the subset is not yet at least the threshold size; that is, the subset does not yet have at least the threshold number of images, then the server 128 returns to block 305 to capture a subsequent image to continue building the subset.

If, at block 335, the subset is at least the threshold size, that is, the subset has at least the threshold number of images, then the server 128 proceeds to block 215 of the method 200.

Returning to FIG. 2, at block 215, after obtaining the subset of images at block 210, the server 128 obtains the image classifications of each of the images in the subset. For example, if the images in the subset were classified during the generation of the subset, such as at block 310 of the method 300, then the server 128 may retrieve such image classifications associated with the images. In other examples, the server 128 may classify (or re-classify) each image in the subset, for example by providing the image to an image classifier as described above.

At block 220, after obtaining the image classifications for the images in the subset, the server 128 determines a representative class for the subset based on the image classifications of the images in the subset. In particular, the server 128 may determine a weighted confidence for each class corresponding to an image in the subset. The weights may vary based, for example on a number of images in each class, the respective confidence levels of the image classification for each image, combinations of the above, and the like. The server 128 may select, as the representative class, the image classification having the largest weighted confidence value. In other examples, other manners of selecting the representative class for the subset are also contemplated.

At block 225, the server 128 determines the current load bay state based on the representative class identified at block 220. In particular, certain classes may be directly associated with certain load bay states.

For example, the load bay state may include a dock state, having possible values of empty and occupied and a trailer door state, having possible values of open, closed, ajar, and NULL. That is, when the dock is occupied by a trailer or container, the trailer door may be either open, closed, or ajar (i.e., in between open and closed). When the dock is empty (i.e., not occupied by a trailer or container), then there is no trailer door, and hence the trailer door state is NULL.

Further, the possible representative classes may be taken from the predefined image classes including, but not limited to: parking lot, trailer door closed, trailer empty, end workflow, lights out, mixed cargo, parcel cargo, and trailer door ajar.

The correspondence between the representative class and the dock state and trailer door state may be predetermined and stored, for example, in the memory 154, and defined as in Table 1:

TABLE 1
Representative class-load bay state correspondence

Load Bay State

| Representative Class | Dock State | Trailer Door State |
|---|---|---|
| Parking Lot | Empty | NULL |
| Trailer door closed | Occupied | Closed |
| Trailer empty | Occupied | Open |
| End workflow | Occupied | Open |
| Lights out | Occupied | Open |
| Mixed cargo | Occupied | Open |
| Parcel cargo | Occupied | Open |
| Trailer door ajar | Occupied | Ajar |

In particular, when the representative class indicates that the image depicts a parking lot view (e.g., visible asphalt, parking lines and/or other road indicators, etc.), then there is no trailer docked at the load bay, and hence the dock state is empty, and the trailer door state is NULL. When the representative class indicates that the image depicts a trailer with its door closed, then there is a trailer visible at the load bay, and hence the dock state is occupied and the trailer door state is closed. Similarly, when the representative class indicates that the image depicts a trailer door which is ajar, then there is a trailer visible at the load bay, and hence the dock state is occupied and the trailer door state is ajar. When the representative class indicates that the image depicts the certain parameters of the trailer (e.g., trailer empty—the interior of the trailer does not have a significant volume of cargo inside, end workflow—the cargo in the trailer is secured by netting and/or some other mechanism, lights out—there is low ambient lighting, mixed cargo—the trailer is handling mixed cargo, parcel cargo—the trailer is handling parcel cargo), then there is a trailer visible at the load bay, and hence the dock state is occupied, and the interior of the trailer is visible in a distinct enough manner to discern load parameters, and hence the trailer door state is open. In such examples, when the dock state is occupied and the trailer door state is open, the load bay state may additionally be updated to include a load parameter defined by the representative class. That is, the load parameter may indicate that the trailer is empty, the type of cargo being handled by the trailer, low lighting conditions of the trailer, or an end workflow of the load process for the trailer.

The server 128 may also be configured to update a stored load bay state to correspond the determined current load bay state. For example, the memory 154 may store the stored load bay state. In some examples, the server 128 may update the stored load bay state, and in particular, the dock state and the trailer door state, with the determined current dock state and current trailer door state, as defined for example in Table 1. In other examples, the server 128 may additionally consider the previously stored load bay state during the update process.

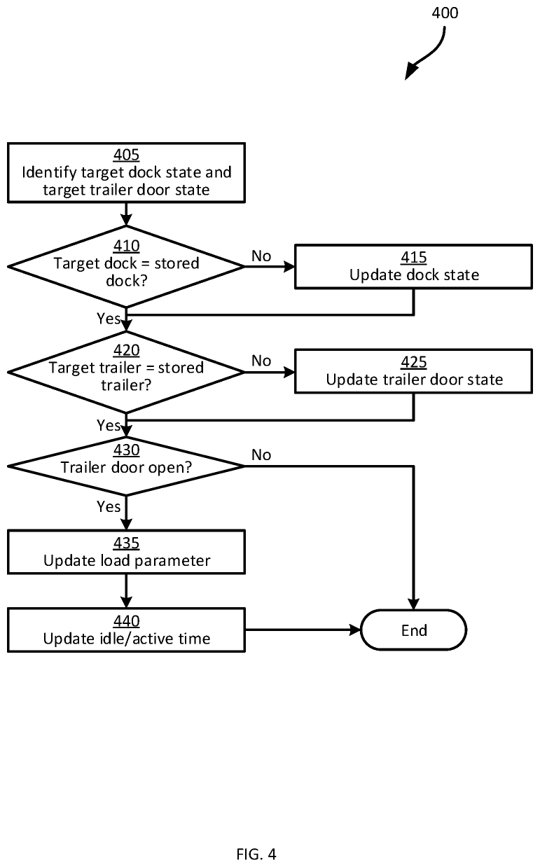

For example, referring to FIG. 4, an example method 400 of updating the stored load bay state is depicted.

At block 405, the server 128 identifies a target dock state and a target trailer door state. In particular, the target dock state and target trailer door state are selected as the current dock state and the current trailer door state, as defined, for example in Table 1.

At block 410, the server 128 determines whether the stored dock state corresponds to the target dock state. If the determination at block 410 is affirmative, that is the stored dock state already corresponds to the target dock state, then no update to the stored dock state is required, and the server 128 proceeds to block 420.

If the determination at block 410 is negative, that is the stored dock state does not correspond to the target dock state, then the stored dock state should be updated. Accordingly, the server 128 proceeds to block 415. At block 415, the server 128 sets the stored dock state to the target dock state. The server 128 may then proceed to block 420.

At block 420, the server 128 determines whether the stored trailer door state corresponds to the target trailer door state. If the determination at block 420 is affirmative, that is the stored trailer door state already corresponds to the target trailer door state, then no update to the stored trailer door state is required, and the server 128 proceeds to block 430.

If the determination at block 420 is negative, that is the stored trailer door state does not correspond to the target trailer door state, then the server 128 proceeds to block 425. At block 425, the server 128 sets the stored trailer door state to the target trailer door state. The server 128 may then proceed to block 430.

At block 430, the server 128 determines whether the trailer door state is/has been set to open. If the determination at block 430 is negative, that is the trailer door state is not open, then the server 128 concludes that no additional load parameters may be determined, and the method 400 ends.

If the determination at block 430 is affirmative, that is the trailer door state is set to open, then the server 128 proceeds to block 435. At block 435, the server 128 updates the load parameters for the current/stored load bay state according to the representative class of the subset. For example, the server 128 may update the load parameter to be empty, parcel or mixed cargo, lights out, or end workflow, as appropriate.

At block 440, having determined that the trailer door state is open (and therefore additionally that a trailer occupies the dock), the server 128 may also update an idle and/or active time. The idle/active time indicates the amount of time a trailer occupies a dock door or a load bay with its door open, and therefore may be accessible to perform load processes.

To determine the active/idle time, the server 128 may analyze the images in the subset. For example, the server 128 may determine the absolute difference between consecutive images and convert the difference to greyscale. The server 128 may then apply a Gaussian blur or other suitable blurring or processing function to the greyscale difference image and apply a threshold. The server 128 may dilate the thresholded image and find contours in the thresholded image. Finally, the server 128 may count the contours with areas greater than a threshold area. If the count of said areas exceeds a threshold number, then the server 128 may determine that there is motion in the trailer (i.e., since the number of significant contours in the difference image is high, the server 128 may conclude that a load process is underway). Similarly, if the count of said areas does not exceed the threshold number, then the server 128 may determine that there is no motion in the trailer (i.e., that there is idle time at the trailer/during the load process). In this manner, the server 128 may additionally track the active and idle times for load processes at the facility.

Returning to FIG. 2, at block 230, the server 128 may transmit the current load bay state to another computing device for output. For example, the server 128 may transmit the current load bay state to one or more of the devices 124 of the worker 116 or the supervisor 132. The computing devices may be configured to display the current load bay state and/or generate one or more alerts relating to the current load bay state. In some examples, the server 128 may output the current load bay state at an output device of the server 128 itself.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
at a load bay, controlling an imaging device disposed at the load bay to capture a plurality of images of the load bay;
at a computing device communicatively coupled to the imaging device:
obtaining a subset of the plurality of images;
obtaining an image classification for each image in the subset; and
determining a load bay state based on the image classifications of the images in the subset.

2. The method of claim 1, wherein each image in the subset is captured within a threshold time of a preceding image in the subset.

3. The method of claim 1, wherein obtaining the subset comprises:
in response to capturing a subsequent image, if the subsequent image is captured within a threshold time of a preceding image in the subset, adding the subsequent image to the subset; and
when the subset includes at least a threshold number of images, completing the subset.

4. The method of claim 3, further comprising: if the subsequent image is not captured within the threshold time of the preceding image in the subset, discarding the subset and generating a new subset with the subsequent image.

5. The method of claim 3, further comprising: obtaining the image classification of the subsequent image; and if a confidence level for the image classification of the subsequent image is below a threshold confidence level, discarding the subsequent image.

6. The method of claim 1, wherein obtaining the image classification comprises processing the image by a machine learning-based image classifier.

7. The method of claim 1, further comprising:
identifying a representative class for the subset based on the image classifications of the images in the subset; and
wherein the load bay state is determined based on the representative class.

8. The method of claim 7, wherein identifying a representative class for the subset comprises selecting the image classification of the images in the subset having a largest weighted confidence.

9. The method of claim 1, wherein the load bay state comprises a dock state, a trailer door state and a load parameter.

10. The method of claim 1, further comprising updating a stored load bay state to correspond to the load bay state.

11. The method of claim 1, further comprising transmitting the load bay state to a further computing device for output at the further computing device.

12. A system comprising:
an imaging device having a field of view encompassing at least a portion of a load bay;
a computing device configured to:
control the imaging device to capture a plurality of images of the load bay;
obtain a subset of the plurality of images;
obtain an image classification for each image in the subset;
determine a load bay state based on the image classifications of the images in the subset.

13. The system of claim 12, wherein each image in the subset is captured within a threshold time of a preceding image in the subset.

14. The system of claim 12, wherein to obtain the subset, the computing device is configured to:
in response to capturing a subsequent image, if the subsequent image is captured within a threshold time of a preceding image in the subset, add the subsequent image to the subset; and
when the subset includes at least a threshold number of images, complete the subset.

15. The system of claim 14, wherein the computing device is further configured to: if the subsequent image is not captured within the threshold time of the preceding image in the subset, discard the subset and generating a new subset with the subsequent image.

16. The system of claim 14, wherein the computing device is further configured to: obtain the image classification of the subsequent image; and if a confidence level for the image classification of the subsequent image is below a threshold confidence level, discard the subsequent image.

17. The system of claim 12, wherein to obtain the image classification the computing device is configured to process the image by a machine learning-based image classifier.

18. The system of claim 12, wherein the computing device is further configured to:
identifying a representative class for the subset based on the image classifications of the images in the subset; and
wherein the load bay state is determined based on the representative class.

19. The system of claim 18, wherein to identify a representative class for the subset the computing device is configured to select the image classification of the images in the subset having a largest weighted confidence.

20. The system of claim 12, wherein the load bay state comprises a dock state, a trailer door state and a load parameter.

21. The system of claim 12, wherein the computing device is further configured to update a stored load bay state to correspond to the load bay state.

22. The system of claim 12, wherein the computing device is further configured to transmit the load bay state to a further computing device for output at the further computing device.
